(19) United States
(12) Patent Application Publication
(10) Pub. No.: US 2011/0082679 A1
(43) Pub. Date: Apr. 7, 2011

(54) Apparatus of simulating data certification with safe network communication

(75) Inventors: Yuan-Chang Yu, Taoyuan City (TW); Hong-Yih Yeh, Xiridian City (TW); Hui-Wen Huang, Guishao Shiang (TW); Ming-Huei Chen, Bude City (TW)

(73) Assignee: ATOMIC ENERGY COUNCIL-INSTITUTE OF NUCLEAR ENERGY RESEARCH, Taoyuan (TW)

(21) Appl. No.: 12/149,595

(22) Filed: May 5, 2008

(51) Int. Cl. G06G 7/62

(52) U.S. Cl. 703/13

(57) ABSTRACT

The present invention provides a simulation. In the present invention, a hardware simulation is replaced with a software simulation. Hence, with the software simulation, cost for buying hardware is saved. At the same time, system functions are effectively certified in a limited time. And speed, quality and safety on testing system modules are thus improved.

### FIELD OF THE INVENTION

The present invention relates to a simulation; more particularly, relates to replacing a hardware simulation with a software simulation to effectively certify system functions in a limited time with improved speed, quality and safety on testing system modules

### DESCRIPTION OF THE RELATED ART

An instrument and control system for a nuclear plant needs to be digitalized. The instrument and control system is a distributed control and information system (DCIS). However the system has a lot of providers and its interface is complicated. In a safety system logic and control/engineered safety feature (SSLC/ESF) of the system, a control I/O module test panel or a control I/O card test panel is operated manually. In addition, for different signals, different signal generators are required and strengths of signals are tuned manually, which costs time and labor, even without good maintenance and auto-testing. As a result, the cost is high, the system is complicated and the time spent is long. Hence, the prior art does not fulfill all users' requests on actual use.

### SUMMARY OF THE INVENTION

The main purpose of the present invention is to replace a hardware simulation with a software simulation to effectively certify system functions in a limited time with improved speed, quality and safety on testing system modules

To achieve the above purpose, the present invention is an apparatus of simulating data certification with a safe network communication, comprising a QOS(quality of service)-guaranteed and real-time safety network, a data acquisition and verification unit, a data provider and a data certification simulator, where all data are stored in a memory bank through the safety network and are replicated to all nodes at real time; when the data acquisition and verification unit receives outside data through the safety network, the data provider simulates data of all nodes on the safety network to provide corresponding data as input to the data acquisition and verification unit to be verified; and the data certification simulator simulates validation bytes of the nodes for the data acquisition and verification unit to take output data of the data provider as valid data. Accordingly, a novel apparatus of simulating data certification with a safe network communication is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the structural view showing the preferred embodiment according to the present invention;

FIG. 2 is the view showing the architecture of the data provider;

FIG. 3 is the view showing the first user interface;

FIG. 4 is the structural view showing the first core model;

FIG. 5 is the view showing the architecture of the data certification simulator;

FIG. 6 is the structural view showing the second core model;

FIG. 7a is the view showing the first state of use of the second user interface;

FIG. 7b is the view showing the second state of use of the second user interface; and

FIG. 7c is the view showing the third state of use of the second user interface.

### DESCRIPTION OF THE PREFERRED EMBODIMENT

The following description of the preferred embodiment is provided to understand the features and the structures of the present invention.

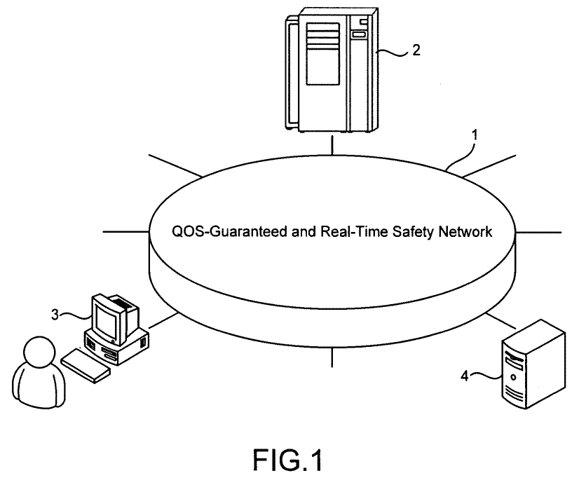

Please refer to FIG. 1, which is a structural view showing a preferred embodiment according to the present invention. As shown in the figure, the present invention is an apparatus of simulating data certification with a safe network communication, comprising a QOS(quality of service)-guaranteed and real-time safety network 1, a data acquisition and verification unit 2, a data provider 3 and a data certification simulator 4, where a hardware simulation is replaced with a software simulation to effectively certify system functions in a limited time with improved speed, quality and safety on testing system modules.

The safety network 1 is a real-time communication network of fiber-optic ring, where the safety network 1 has a communication protocol based on a replicated memory; and all data are stored in a memory bank and are replicates to every node at real time. The safety network 1 is a redundant independent and isolated network. When an error occurs at a network, another network takes responsibility immediately without any harm to response time or control algorithm. Therein, every node of the safety network 1 comprises a plurality of modules of control, input and output; and the modules have a method of real-time data exchange applied to the memory bank of the safety network 1. And an auto error detection and correction are used to maintain data integrity. And the data is transferred through hardware without software or firmware.

The data acquisition and verification unit 2 is a physical cabinet, comprising a network interface module and a control I/O module. The data acquisition and verification unit 2 receives outside data through the safety network 1; and the data are validation bytes from a source node to verify whether the source node is still available on the safety network 1. If the validation bytes from the source node are refreshed within 20 milliseconds (ms), data sent from the source node are taken as valid for reading. Hence, every cabinet in the data acquisition and verification unit 2 scans all I/Os of the control I/O module per 20 ms by the network interface module to process control and to refresh data; and a result of the scanning is shown on a related user interface through an online detection function contained in the control I/O module. Therein, every cabinet in the data acquisition and verification unit 2 communicates with each other through a redundant network interface module; and the control I/O modules in the same cabinet communicate through a back plane bus. The control I/O module of the data acquisition and verification unit 2 comprises an analog signal output module, an analog signal control module, an analog signal input module, a digital signal control module, a digital signal output module, a thermocouple (T/C) input module and a resistance temperature detector (RTD) input module. The network interface module has three methods of: (a) scanning data transferred from the control I/O module to the safety network 1 per 20 ms, passing through and receiving data by the control I/O module, and providing status signal to the control I/O module by the source node per 20 ms; (b) diagnosing the cabinet and the safety network, including a power-availability status, a temperature in the cabinet, a networking status and a control I/O module status; and (c) exchanging data between the safety network and the control I/O module and monitoring status of each node.

After the data acquisition and verification unit 2 receives output data, it is required to certify correctness of the related output data. Hence, the data provider 3 simulates data for all nodes on the safety network 1. Based on input data of other nodes on the safety network 1 requested by the data acquisition and verification unit 2, a simulation is processed per 20 ms by sending corresponding data to the data acquisition and verification unit 2 through the safety network 1 for certification.

While output of a hardware is changed into output of the data provider 3, the data certification simulator 2 uses a man-machine interface to select validation bytes of node. There are some nodes on the safety network 1; and there is no node having a duplicate address. The man-machine interface is used to dynamically change and simulate refreshment of the validation bytes of a selected node based on a requirement. Hence, with the validation bytes refreshed by the data certification simulator 4 per 20 ms, validation bytes of the node are simulated by the data certification simulator 4 while data are received through the data acquisition and verification unit 2. Thus, the data acquisition and verification unit 2 certifies data outputted from the data provider 3.

Consequently, the present invention has a high speed with the safety network 1. The present invention has a simple design and requires no complicated communication protocol. Thus, software malfunctions or network data package collisions are eliminated and a reliable transferring time without supports of an operation system or related network protocols is obtained. Furthermore, the present invention do not need physical hardware for outputting data; and, thus, cost on buying hardware equipments is saved.

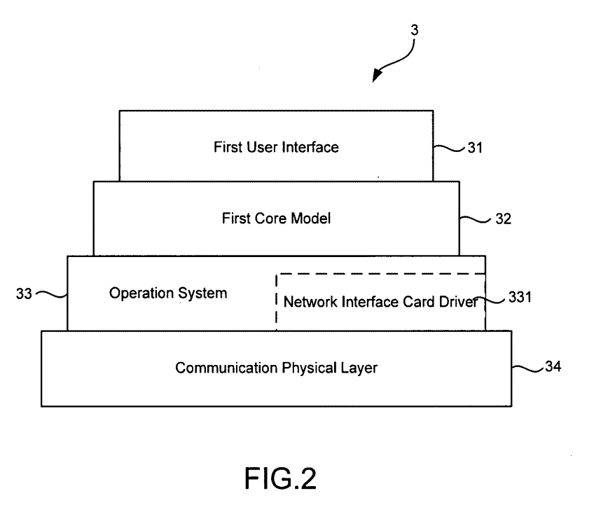

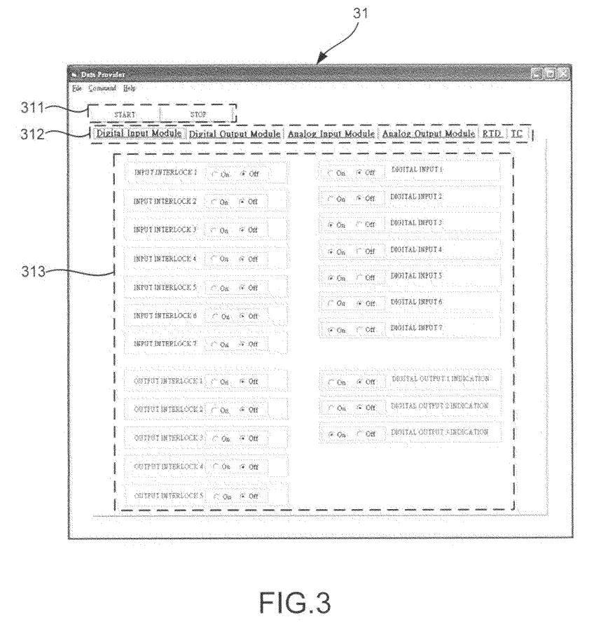

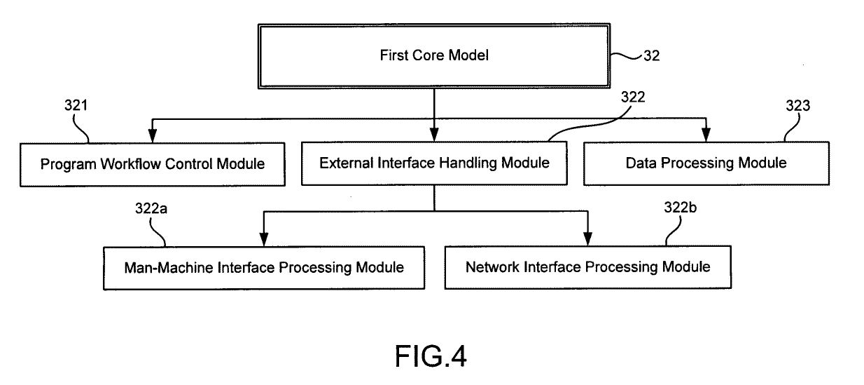

Please refer to FIG. 2 to FIG. 4, which are a view showing architecture of a data provider; a view showing a first user interface; and a structural view showing the first core model. As shown in the figures, architecture of a data provider comprises a first user interface 31, a first core model 32, an operation system 33 and a physical communication layer 34, where the first core model 32 comprises a program workflow control module 321, an external interface handling module 322 and a data processing module 323; and the physical communication layer is a QOS-guaranteed and real-time safety network.

The first user interface 31 comprises a ‘Start/Stop Transmission’ button 311, a TabStrip control unit 312 and a simulated data group 313, where the simulated data group 313 sets up simulated data; the TabStrip control unit 312 selects the data to be simulated; and the ‘Start/Stop Transmission’ button starts or stops the simulation. When the program starts, the operation system 32 is provided as a platform to run the first core model. The program workflow control module 321 loads the setups to initialize all parameters and controls the processing of the data provider. A man-machine interface processing module 322a of the external interface handling module 322 is used to receive and process the data setup by the first user interface 31. Then a network interface processing module 322b of the external interface handling module 322 is used to process data on the safety network through a network interface card driver of the operation system 33, including fetching network data, verifying network data and writing network data. At last, the data processing module 323 of the first core model 32 is used to read the simulated data setup by the first user interface 31; the data is transformed according to a communication protocol of the safety network; and then the transformed data is written over the physical communication layer 34. Moreover, the data processing module 323 analyzes data packages from the safety network; and the simulated data group 313 of the first user interface is used to show its meaning. Therein, the program workflow control module 321 starts or stops providing data and coordinates the external interface handling module 322 and the data processing module 323.

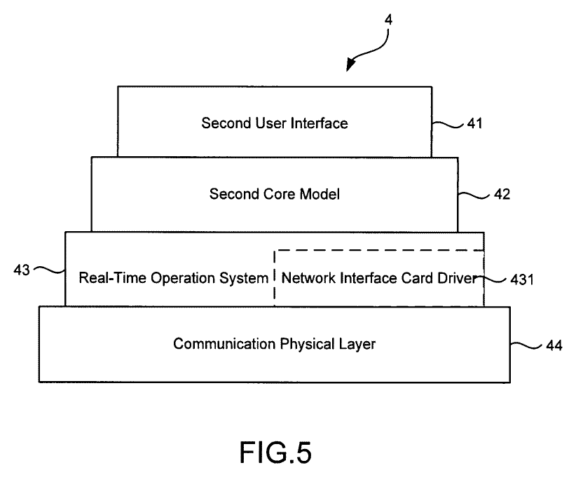

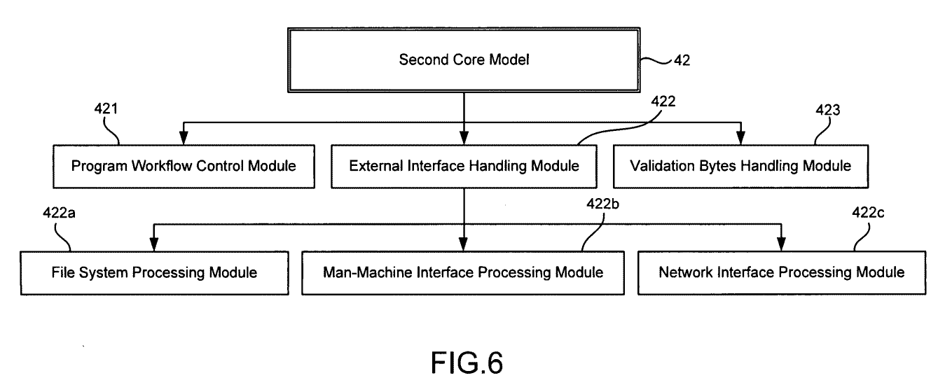

Please refer to FIG. 5 and FIG. 6, which are a view showing architecture of a data certification simulator; and a structural view showing a second core model. As shown in the figures, a data certification simulator according to the present invention comprises a second user interface 41, a second core model 42, a real-time operation system 43 and a physical communication layer 44, where the second core model 42 comprises a program workflow control module 421, an external interface handling module 422 and a validation byte handling module 423; and the physical communication layer 44 is a QOS-guaranteed and real-time safety network.

The second user interface 41 comprises a Start button, a ‘Clear All’ button, an ‘Auto Set’ button and a node group, where the node group sets up nodes dynamically to be selected for simulation; and the Start button starts or stop the simulation. When the program starts, the real-time operation system 43 provides a timer to the second core model 42, which has a minimum resolution of 4 ms. With a default and precise interrupt of 20 ms, validation bytes of the node selected are simulated and refreshed. After the program starts, the program workflow control module 421 of the second core model 42 loads default setups from a file system for initializing all parameters to control whole simulation flow of the data provider. A file system processing module 422a of the external interface handling module 422 accesses data in an external file system to read or write setup files. A man-machine interface processing module 422b of the external interface handling module 422 receives and processes setups and commands through the second user interface 41. Then a network interface processing module 422c of the external interface handling module 422 processes data on the safety network through the network interface card driver 431 of the real-time operation system 43. In the end, the validation byte handling module 423 of the second core model 42 figures out a corresponding physical network address on the safety network to rapidly and acutely refresh validation bytes of the nodes through the physical network address, the interrupt of the timer and the network interface processing module 422c. And then the network interface card driver 431 writes data to the safety network or the physical communication layer 44. Therein, the program workflow control module 421 starts or stops the simulation and coordinates the external interface handling module 422 and the validation byte handling module 43.

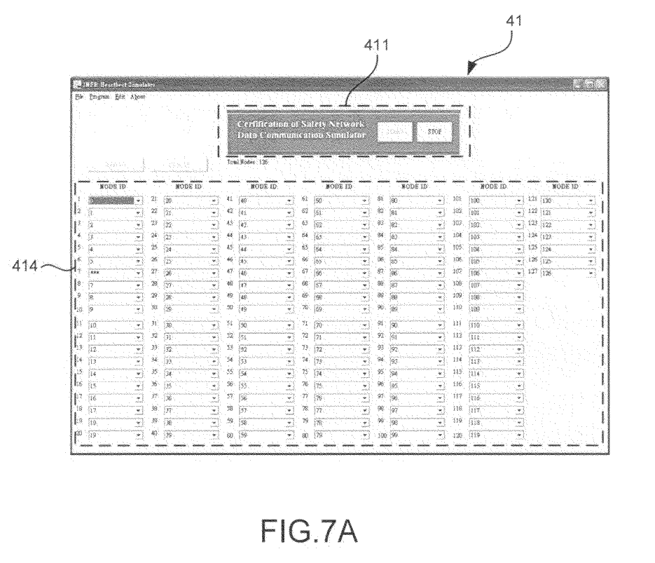

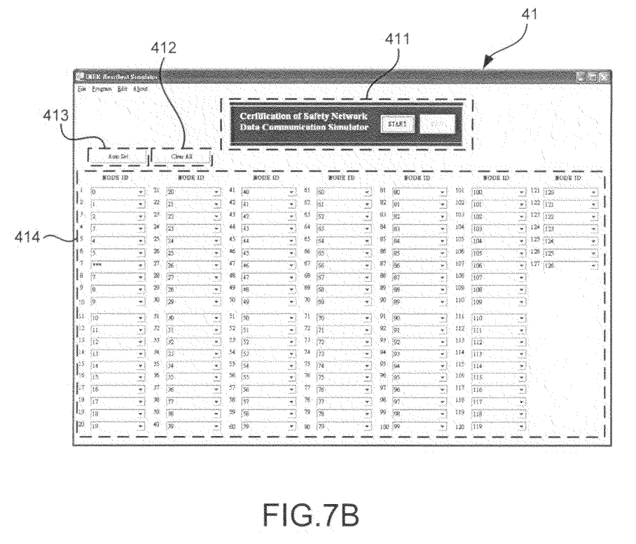

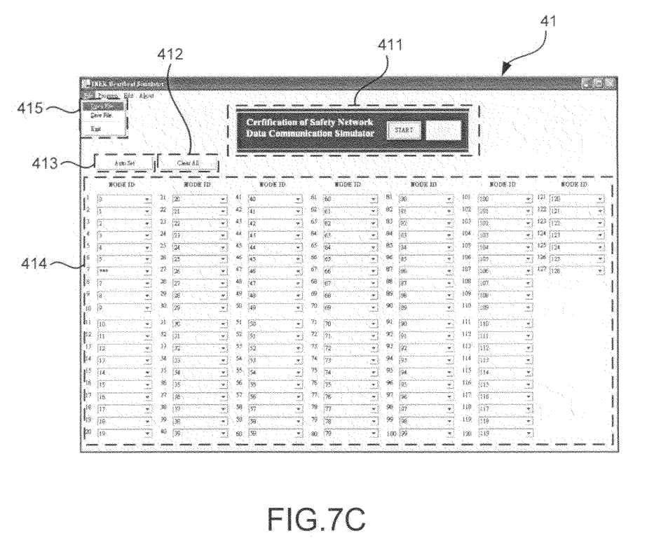

Please refer to FIG. 7a to FIG. 7c, which are views showing a first state of use, a second state of use and a third state of use of a second user interface. As shown in the figures, on starting a simulation, a Start button 411 of a second user interface 41 blinks to notify processing of the simulation and a number of simulated nodes is displayed. At the moment, changing setup is forbidden. When the simulation ends, the Start button 411 stops blinking and setups become changeable.

A node group 414 of the second user interface 41 is used to select and setup nodes for simulation. There are 127 nodes numbering from 0 to 126 separately. A node is enabled by selecting the number of the node; or else, is disabled by selecting ‘****’.

The second user interface 41 has a ‘Clear All’ button 412 and an ‘Auto Set’ button 413 for rapid setup. The ‘Clear All’ button 412 is used to clear all setups for conveniently setting up several nodes only. And the ‘Auto Set’ button 413 is used to rapidly enable all nodes.

Besides, the second user interface provides a pull-down menu 415 for various simulations. Setup files of the simulations are managed by writing in and reading out through the pull-down menu 415.

To sum up, the present invention is an apparatus of simulating data certification with a safe network communication, where a hardware simulation is replaced with a software simulation to effectively certify system functions in a limited time with improved speed, quality and safety on testing system modules.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. An apparatus of simulating data certification with a safe network communication, comprising:
a QOS(quality of service)-guaranteed and real-time safety network, said safety network being a fiber-optic ring network, said safety network storing all data in a memory bank and replicating all data to every node in said safety network at real time;
a data acquisition and verification unit, said data acquisition and verification unit being a physical cabinet, said cabinet comprising a network interface module and a control input/output (I/O) module, said data acquisition and verification unit receiving outside data through said safety network;
a data provider, said data provider simulating data for every node on said safety network, said data provider inputting said data to said data acquisition and verification unit to be verified; and
a data certification simulator, said data certification simulator simulating validation bytes and providing said validation bytes to said data provider, said validation bytes being outputted to every node from said data provider.

2. The apparatus according to claim 1,
wherein every node of said safety network comprises a plurality of modules of control, input and output.

3. The apparatus according to claim 1,
wherein data of said modules of control, input and output are interexchanged in said memory bank of said safety network physically.

4. The apparatus according to claim 1,
wherein said data acquisition and verification unit takes source data from a node as valid data by scanning a refreshment of said validation bytes per 20 milliseconds (ms).

5. The apparatus according to claim 1,
wherein every cabinet in said data acquisition and verification unit scans all I/Os of said control I/O module in said cabinet per 20 ms by said network interface module.

6. The apparatus according to claim 1,
wherein said control I/O module has an online detection.

7. The apparatus according to claim 1,
wherein every cabinet in said data acquisition and verification unit communicates through a redundant network interface module; and
wherein said control I/O module in said cabinet communicates through a back plane bus.

8. The apparatus according to claim 1,
wherein said network interface module has three methods of:
(a) scanning data I/O of said control I/O module through said safety network, and providing status signal to said control I/O module by said node per 20 ms;
(b) diagnosing said cabinet and said safety network; and
(c) exchanging data between said safety network and said control I/O module, and monitoring status of each node.

9. The apparatus according to claim 8,
wherein said method (b) diagnoses a power-availability status, a temperature in said cabinet, a networking status and a control I/O module status.

10. The apparatus according to claim 1,
wherein said control I/O module comprises an analog signal output module, an analog signal control module, an analog signal input module, a digital signal control module, a digital signal output module, a thermocouple (T/C) input module and a resistance temperature detector (RTD) input module.

11. The apparatus according to claim 1,
wherein said data provider transfers data to said data acquisition and verification unit per 20 ms through said safety network.

12. The apparatus according to claim 1,
wherein said data provider comprises a first user interface, a first core model, an operation system and a physical communication layer.

13. The apparatus according to claim 12,
wherein said first user interface comprises a ‘Start/Stop Transmission’ button, a TabStrip control unit and a simulated data group.

14. The apparatus according to claim 12,
wherein said first core model comprises a program workflow control module, an external interface handling module and a data processing module.

15. The apparatus according to claim 14,
wherein said external interface handling module comprises a man-machine interface processing module and a network interface processing module.

16. The apparatus according to claim 1,
wherein said data certification simulator refreshes said validation bytes of said node per 20 ms.

17. The apparatus according to claim 1,
wherein said data certification simulator comprises a second user interface, a second core model, a real-time operation system and a physical communication layer.

18. The apparatus according to claim 17,
wherein said second user interface comprises a ‘Start’ button, a ‘Clear All’ button, an ‘Auto Set’ button and a node group.

19. The apparatus according to claim 17,
wherein said second core model comprises a program workflow control module, an external interface handling module and a validation byte handling module.

20. The apparatus according to claim 19,
wherein said external interface handling module comprises a file system processing module, a man-machine interface processing module and a network interface processing module.
